(19) United States
(12) Patent Application Publication
(10) Pub. No.: US 2013/0282465 A1
(43) Pub. Date: Oct. 24, 2013

(54) AFFINITY REWARDS PROGRAMS

(71) Applicants: Andrew E. Fitzhugh, Menlo Park, CA (US); Ehud Chatow, Palo Alto, CA (US)

(72) Inventors: Andrew E. Fitzhugh, Menlo Park, CA (US); Ehud Chatow, Palo Alto, CA (US)

(21) Appl. No.: 13/453,084

(22) Filed: Apr. 23, 2012

(51) Int. Cl. G06Q 30/02

(52) U.S. Cl. 705/14.27

(57) ABSTRACT

The disclosure relates to affinity rewards program methods and systems. In one aspect, a sponsor participates in an affinity rewards program by transmitting to a rewards program administrator an offer record including a sponsor identifier, an offer reward, and a reward interaction condition. The sponsor receives from a user a unique user identifier associated with an affinity passport which includes the user identifier in readable form and which is associated with the rewards program. The sponsor transmits to the rewards program administrator an event record including the user identifier, the sponsor identifier, and event information defining a user-sponsor interaction. The sponsor receives from the rewards program administrator an indication whether the event information meets the interaction condition and qualifies the user for the sponsor's reward.

### BACKGROUND

Affinity programs offer rewards to customers in exchange for actions which benefit the business. Retailer-specific affinity cards such as for grocery stores, gas stations, and department stores provide rewards to customers in exchange for frequent purchases.

### DESCRIPTION OF THE DRAWINGS

The following detailed description of the various disclosed methods, process, systems, and apparatus refers to the accompanying drawings in which:

FIG. 1 is a flowchart illustrating an embodiment of an affinity rewards program.

FIG. 2A illustrates an example of an affinity passport according to the disclosure.

FIG. 2B illustrates example sponsor-affinity passport relationships according to the disclosure.

FIGS. 3A-3C are flowcharts illustrating various example methods of obtaining a user-registered passport according to the disclosure.

FIGS. 4A and 4B are diagrams illustrating example methods and systems for administering an affinity rewards program according to the disclosure.

FIG. 5 is a diagram illustrating example methods and systems for sponsor participation in an affinity rewards program according to the disclosure.

FIG. 6 is a diagram illustrating example methods and systems for dynamic sponsor monitoring and updating of its affinity rewards program according to the disclosure.

FIG. 7 is a diagram illustrating example methods and systems for user monitoring of its participation in an affinity rewards program according to the disclosure.

FIG. 8 is a diagram illustrating example systems and apparatus for use with and for performance of elements of the disclosed affinity rewards program.

### DETAILED DESCRIPTION

A passport program offered by a business provides a consumer or patron using the passport with an incentive to perform certain actions benefitting the business. The incentive can be in the form of a reward in exchange for visiting a location, making a purchase, or completing some other activity.

Passport programs, however, can be relatively inflexible and can pose substantial entry barriers, in particular for smaller businesses. Passports tied to printed materials incur costs whenever additional passports are created or the program parameters are changed. Infrastructure investment also is required by the business to manage the program's offers, participants, and rewards.

The disclosure relates to an affinity rewards program involving a plurality of users/consumers, at least one sponsor/business, and an affinity rewards administrator (e.g., where the rewards administrator is a distinct entity from at least one or all of the participating sponsor(s)). The program provides a dynamic platform for sponsors to distribute rewards (e.g., physical or digital items, credit, money, discounts/coupons, etc.) to users for actions benefitting the sponsor.

The platform allows secure, flexible rewards system implementation with any desired reward parameters and with very little set-up cost. There are little to no entry barriers for sponsor participation, for example digital passports that have no manufacturing cost or printed/physical passports that need not be re-created to implement a rewards program with different or variable offer conditions. The program is managed by a centralized affinity rewards administrator using a generalized internet (cloud) computing service to create a flexible system allowing essentially any size business to participate with little or no resource investment for program management. The centralized administrator platform beneficially permits event tracking from multiple sponsors, offers, and/or users, thus providing real-time feedback to participants and allowing the sponsor participants to data mine their offer programs (and the programs of others) to enhance future marketing efforts. The centralized administrator platform further provides a convenient mechanism for consolidated rewards program management for a user who can monitor and/or manage his/her program activity for a number of different sponsors through a single administrative portal.

Sponsors participate in the program by defining an offer that generates a reward when any desired set of conditions is met by a user (e.g., time-, place-, or event-specific conditions). The central affinity rewards administrator coordinates the program and maintains both user and sponsor information. A particular rewards offer can have any desired number of sponsors, number of associated sponsor locations, and offer lifespan. In one example, an offer can be related to a single sponsor at a single location (e.g., a small business having a single operating location). In another example, an offer can be related to a single sponsor at multiple locations (e.g., a small or large business having multiple operating locations, where specific rewards can be location-dependent). In another example, an offer can be related to multiple sponsors at multiple locations (e.g., multiple businesses having multiple operating locations, where specific rewards can be location- and/or sponsor-dependent). In any of these instances, the offer (e.g., as well as a corresponding passport) can be intended for both short- and long-term promotional programs. For example, the offer can have a finite lifespan (e.g., offer valid only for a preselected period of hours, days, weeks, months, etc.) or the offer can have an indefinite lifespan (e.g., offer valid on an ongoing basis related to continued user activity, potentially with time- and/or location-varying offer/reward conditions).

The ability of the rewards administrator to provide feedback/use statistics (e.g., essentially real-time data) to a sponsor allows the sponsor to monitor and evaluate the relative success or failure of a particular rewards offer. As a result, the sponsor can adapt existing offers to improve their success rate and/or create new offers directed to identified current/past user activity that does generate a reward (e.g., representing a successful program) or that does not currently generate a reward (e.g., which provides an opportunity for a new, successful program).

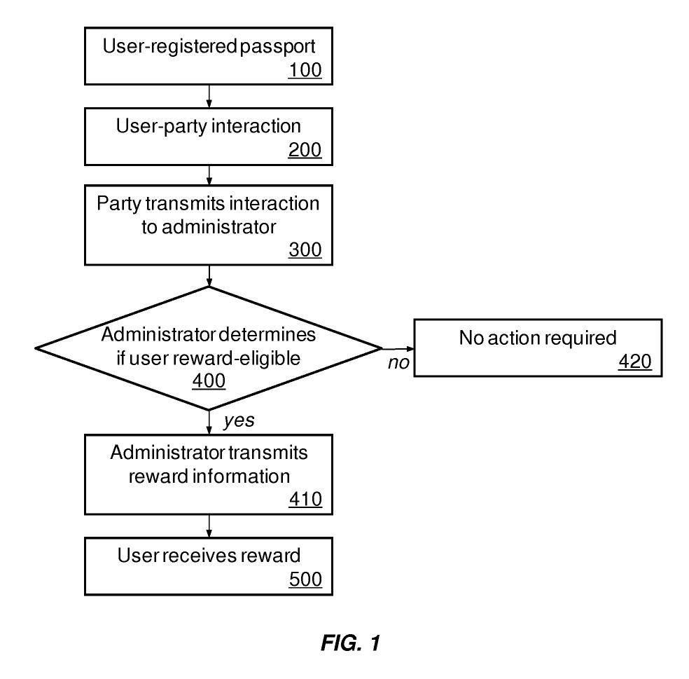

FIG. 1 is a flowchart and provides an overview of an affinity rewards program according to the disclosure. Users participating in the rewards program have a registered affinity passport 100. As described in more detail below, the passport 100 includes a unique user identifier/index or user identification code (UIC) such as a 2D barcode or other machine-readable identifier. The passport 100 is registered with an affinity rewards administrator so that the passport 100 can be used to earn rewards. Suitably, the administrator maintains at least one item of contact information for the particular user(s) registered to the passport 100, thus allowing the administrator to notify the user regarding any reward for which the user is eligible (e.g., via email, telephone, text message, mail, etc.).

When a user interacts with a party such as a sponsor or other sponsor-related (third) party participating in the rewards program, a user-party interaction 200 is generated/defined. The nature of the interaction 200 is not particularly limited and can include, for example, a user visit to the party's location, a user purchase from the party, a user performing a specific activity at the party's location, etc. In one example, the interaction 200 is a physical interaction between the user's person and the party (e.g., where the user is physically present at the party's location/place of business). In another example, the interaction 200 is a virtual interaction between the user and the party (e.g., where the user's visit/purchase/activity is performed remotely via the internet at the sponsor's internet location/website). In some cases, the party with whom the user interacts is the sponsor or sponsor-affiliate (e.g., the party defining the offer/reward parameters and/or providing the reward to the users). In other cases, the party with whom the user interacts is a related third party having a pre-existing relationship with the offer sponsor (e.g., where the third party interacts with the user and transmits the related event/interaction information to the sponsor or to the reward program administrator on behalf of the sponsor). The interaction 200 can be further defined in terms of additional information items, such as interaction time (e.g., date, time of day, or both; at a discrete time or within a defined time range), interaction location (e.g., physical or virtual location), interaction value (e.g., monetary value of a purchase, further including purchase item(s) if desired), interaction user (e.g., age, gender, occupation or other information category of the user beyond the user identifier) and/or interaction activity performed. Even though the passport 100 may be used in purchase interactions 200 to accumulate rewards, the passport 100 suitably does not serve as a payment or purchase means (e.g., the passport 100 is not intended to serve or is incapable of serving as a payment means such as a credit card, debit card, etc.). Similarly, in some cases, the passport 100 is used in an environment unrelated to commercial activity by the user for purposes of reward distribution (e.g., the interaction 200 and corresponding sponsor offers relate to non-purchase activity or activities not involving monetary transactions).

The party then transmits (300) the details concerning the interaction 200 to the rewards administrator. The transmission 300 generally includes any or all event information defining the nature of the interaction 200 as well as indicia identifying the sponsor (e.g., which can be the transmitting party), transmitting party (e.g., when not the sponsor), and user. The administrator determines (400) whether the particular interaction 200 qualifies the user for a reward (e.g., whether the interaction 200 meets the pre-defined offer reward conditions provided by the sponsor; whether the user/passport corresponds to an active, registered user/passport). In some cases, the administrator additionally authenticates the interaction 200 and corresponding event record/interaction information, for instance to verify that the transmitting party is a valid participant in the rewards program and/or to verify the integrity of the event information (e.g., to prevent unauthorized use of the affinity passport and/or to prevent fraud on the reward program). Any suitable form of authentication/secured transmission may be used, for example where the transmitting party digitally/cryptographically signs the transmission 300 for subsequent administrator verification. If the user is eligible to receive the reward, the administrator transmits (410) award eligibility information to the user, the sponsor, and/or the transmitting third party. For example, the administrator may notify the user that the user is eligible to receive the reward along with instructions how to obtain/receive (500) the reward from the sponsor, rewards administrator, or other party. Alternatively or additionally, the administrator may notify the sponsor or third party that the user is eligible to receive the reward, for example so that the sponsor or third party can provide (500) the reward to the user (e.g., immediately subsequent to the interaction 200 event or at a later time). Although no action is required (420) if the user is not eligible to receive the reward, the administrator suitably may notify the user and/or the sponsor or third party accordingly, and the administrator may additionally store the non-reward event for subsequent data evaluation by the sponsor or the user. For example, the administrator can inform the user that no reward is due, or the administrator can inform the user regarding the relative degree of completion toward a multi-part offer requiring multiple events for completion.

The specific nature of the reward granted to the user is not particularly limited. For example, the reward can include a physical item, a digital item, sponsor credit, and/or money. Examples of physical items include merchandise and coupons from the sponsor or from a third party. Examples of digital items include software applications or components/enhancements for an existing application of the user, digital media files (e.g., images, audio, video), and digital coupons.

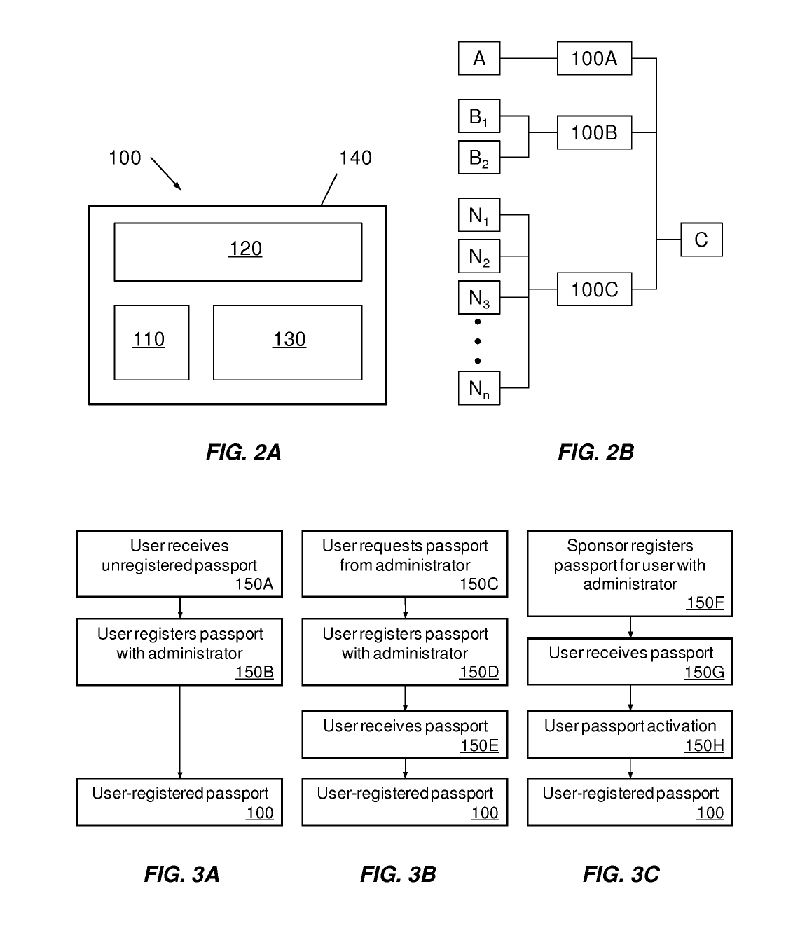

FIG. 2A illustrates an example of an affinity passport 100 according to the disclosure. The passport 100 includes a unique index 110 that can be used to uniquely identify the passport 100 and, if desired, also to identify at least one user associated with the passport 100. The property of uniqueness may be applied to all passports 100 in general, all passports 100 associated with a particular rewards administrator, or all passports 100 associated with a selected sponsor or set of sponsors. The index 110 suitably includes a unique user identification code (UIC), for example an alphanumeric code/index for the user identifier. The index 110 is in a readable form, whether readable by a human (e.g., visible code/index such as printed letters/numbers), by a machine (e.g., optically readable, magnetically readable, electromagnetically readable in the radio-frequency domain, etc.), or by multiple human and/or machine means. Examples of suitable machine-readable optical indices 110 include 1D (line) barcodes, 2D (matrix, such as a QR code) barcodes, and radio-frequency identification (RFID) transmitters.

In addition to the unique user identifier, the index 110 suitably includes a uniform resource identifier (URI) or uniform resource locator (URL) associated with at least one of the user, the sponsor(s), and the rewards administrator. The URI/URL can be in human- and/or machine-readable form as above (e.g., visible to a user for manual internet navigation, encoded by a 2D barcode to enable automated internet navigation/redirection upon scanning). The presence of the URI/URL can facilitate a user inquiry or registration process for his/her passport 100 (e.g., by directing the user to an internet site specific to the passport 100). In some examples, the user identifier and any corresponding URI/URL are not present on the passport 100 in human-readable form. In such cases, the user identifier and/or URI/URL can be in an encrypted form (e.g., using public key encryption or other suitable encryption method to encrypt the user's identity, the sponsor's identity, or both). Such encryption can be utilized to limit or prevent unauthorized use of the passport, such as by (i) someone other than the registered/authorized user and/or (ii) the user himself/herself (e.g., where the user attempts to obtain improper rewards such as in excess of those permitted according to a given offer definition for a sponsor). Decryption and authentication of the user identifier and/or URI/URL suitably is performed by the program administrator upon receipt of a given interaction 200 from a party.

In addition to the unique index 110, the passport 100 can include readable indicia 120 identifying the rewards administrator and/or the sponsor(s) associated with the passport 100. Additionally or alternatively, the passport can include readable promotional material 130. The promotional material 130 can be an advertisement for various sponsor(s), which sponsor(s) can be the same or different from the sponsor(s) associated with the passport 100. For example, the promotional material 130 can provide details regarding the specific offer/event/reward parameters for the sponsor(s) associated with the passport 100. Alternatively or additionally, the promotional material 130 can be unrelated to the specific offer/reward parameters for the sponsor(s) associated with the passport 100. The combination of the index 110 and the promotional material 130 creates an incentive to the users to retain the passport 100 and correspondingly increases the return on investment on marketing costs associated with the offer/rewards program. Similar to the index 110, the indicia 120 and the promotional material 130 can be in human- and/or machine-readable form. When in machine-readable form, the indicia 120 and/or promotional material 130 may be integrated into the same medium/form as the index 110. For example, a 2D barcode or other machine-readable index 110 may encode the user identifier as well as the sponsor identifier, rewards information, and/or offer/event information such that any or all of the additional information items may be read along with the user identifier and transmitted to the rewards administrator as desired.

The passport 100 includes a medium 140 that displays/contains the user index 110, the administrator/sponsor indicia 120 (when present), and the promotional material 130 (when present). The medium 140 can be a physical object such as plastic (e.g., in the shape/size of a conventional credit card or otherwise), cardstock, or paper containing the information items 110, 120, and 130. For example, the index 110 in human- and/or machine-readable form can be printed on the plastic, cardstock, or paper medium 140 to provide a dedicated physical object serving as the passport 100. In another example, the medium 140 can be a digital device/object such as a computerized display containing the information items 110, 120, and 130. For instance, the index 110 in human- and/or machine-readable form can be displayed on the screen of a mobile computing device (e.g., smart phone, tablet computer, a personal digital assistant (PDA), a music player, an e-book reader). When the passport 100 is in electronic/digital form, the information items 120, 130 may be changed (e.g., by the administrator and/or the sponsor) at any desired intervals. For example, the promotional material 130 can be changed based on the current time of day and/or the user's current location (e.g., physical location such as determined by a GPS in the user's mobile device; virtual/internet location such as determined by recent web browsing activity with the user's mobile device). In some cases, the user may possess the passport 100 in both physical and digital forms (e.g., a user having a printed physical passport 100 as well as the ability to display the equivalent index 110 from the physical passport 100 on the user's mobile computing device as a digital passport 100).

When a given offer definition requires direct physical interaction between the user and the sponsor as a reward condition, the use of the passport 100 in physical form provides an element of security because the user must physically possess the passport 100 to perform actions that potentially qualify for a reward. In some examples, the passport 100 may incorporate a copy-protection mechanism to limit or prevent unauthorized duplication and/or use of the passport 100. For example, a passport 100 can incorporate a watermark (e.g., printed or digital in visible or invisible form) or other difficult-to-copy image that is present in human- and/or machine-readable form. Similarly, a passport 100 displayed in digital form on a mobile computing device may be registered to a specific mobile device (e.g., via a unique hardware or other identifier associated with the mobile device). In this way, a user must still possess the appropriate registered mobile device to use the passport 100, even when the passport 100 is in a digital form. Additionally, a passport 100 may be configured to require a user to enter a PIN or password (e.g., at the sponsor's location) when using the passport 100.

In some cases, the passport 100 is intended only for use with offers/rewards for the sponsor(s) selected at the time the passport 100 is created/issued. For example, as illustrated in FIG. 2B, Company A may issue a passport 100A for use with Rewards Administrator C. In this case, the passport 100A may only be used for offers from Company A as the sponsor, even though the number and nature of available offers from Company A may change over time. Similarly, Companies B₁ and B₂ may issue a passport 100B for use with Rewards Administrator C such that the passport 100B may only be used for offers from Companies B₁ and B₂ as the sponsors. In other cases, the passport 100 is generic and is not necessarily linked to any particular fixed sponsor or set of sponsors when the passport 100 is created/issued. For example, Rewards Administrator C may issue a passport 100C that a user may use to participate in rewards programs offered by any number of sponsors N₁ . . . Nₙ, some of which may become associated with the Rewards Administrator C at some time after the passport is issued/registered.

FIGS. 3A-3C are flowcharts illustrating various methods of obtaining a user-registered passport 100 according to the disclosure. A registered status indicates that the passport 100 is activated and able to be used by a user to generate reward events. An unregistered status indicates that the passport 100 is not activated and it does not generate reward events, even when a user performs an activity that would otherwise qualify as an award-eligible interaction 200 for a particular sponsor/offer. FIGS. 3A-3C illustrate various non-exclusive tasks 150A-150H that provide a user with a registered passport 100, whether in physical and/or digital form.

As shown in FIG. 3A, a user can receive an unregistered passport 150A through any suitable means. For example, the unregistered passport 150A may be sent via (unsolicited) mail or email to the user by the rewards administrator or a participating sponsor. Alternatively, the user may pick up the unregistered passport 150A at a physical location such as a kiosk, for example a kiosk associated with the rewards administrator or the participating sponsor. If the user is interested in participating in the rewards program (e.g., as a result of promotional or descriptive material provided with or on the unregistered passport 150A), the user registers (150B) the unregistered passport 150A with the program administrator. The registration conveniently can be performed remotely (e.g., over the internet via a web interface), and any URI/URL information contained on the unregistered passport 150A can facilitate the process. For example, an optically readable index 110 on the unregistered passport 150A can be scanned with a internet-enabled mobile computing device, and the URI/URL contained on the unregistered passport 150A can be used to automatically navigate the user to a (web) registration interface, where the user can provide any additional information requested or required by the registration process as described below. In some cases, a registered passport 100 may be re-useable in the sense that it can be subsequently re-registered to a different user/person. In other cases, a registered passport 100 may be limited to the original registering user such that re-registration attempts are not allowed. As a result of this process, the original unregistered passport 150A can become the registered passport 100. In some cases, the user may receive a digital version of the registered passport 100 (e.g., as displayable index 110 on a user's mobile device), either in place of or in addition to a physical version of the passport 100.

In some cases, the registration process may not require the user to provide any additional information; the user merely activates the particular index 110/user identifier on the unregistered passport 150A for subsequent registered use. In this case, the rewards administrator need not maintain contact or other information for the user such that any holder of the registered passport 100 can use the passport 100 and redeem any eligible awards through the respective sponsor (e.g., the passport 100 need not be associated with any user-specific information other than its index 110). Similarly, the administrator does not contact/notify the user of eligible awards, but the user can perform a query of its reward activity/eligibility via the various administrator databases (e.g., over the internet via a web interface).

In other cases, the registration process may require the user to provide at least some additional information, for example including at least one item of contact information (e.g., physical (mailing) address, electronic (email) address, telephone number (home, mobile, business)), at least one item of demographic information (e.g., age, gender, family status, education, occupation, general geographic location such as city, state, country, or region(s) thereof), and/or at least one item of security information (e.g., (encrypted) password or PIN for use of passport, access of passport activity, and/or redemption of awards). In this case, the rewards administrator may maintain the additional information for the user (e.g., in a user database associating the additional information with the passport index 110/user identifier), in which case reward disposition can be limited to a valid, registered use of the passport 100. Similarly, the administrator can use the additional information to contact/notify the user of eligible awards. In an extension of the registration process, more than one valid user may be associated with a particular passport index 110/user identifier, thus allowing any desired grouping of users (e.g., members of the same family, business, club, etc.) to be associated with and to qualify for rewards with the passport 100.

In another example shown in FIG. 3B, a user can request (150C) a passport 100 from the rewards administrator. For example, the user may learn of the offer/reward opportunities through some promotional material or other means, and the user can use a passport-request web interface to register (150D) the passport 100 with the administrator. The registration process may or may not require additional user information as described above to activate the passport 100 for use. The user then receives (150E) the registered passport 100, for example via mail and/or via electronic delivery from the administrator or a participating sponsor.

In yet another example shown in FIG. 3C, a sponsor registers (150F) a passport 100 for a user through the rewards administrator. The registered passport 100 provided by the sponsor may contain no additional user information beyond the passport index 110/user identifier, thus allowing user receipt (150G) of a registered passport 100 through a solicited or unsolicited promotional program on behalf of the sponsor. In another example, the registered passport 100 may contain additional user information beyond the passport index 110/user identifier, for example based on user information possessed by the sponsor (e.g., in the sponsor's customer records). Each pre-registered user then receives (150G) the registered passport 100 directly (e.g., from the sponsor). In some cases, the rewards administrator or the sponsor may require user activation (150H) of a pre-registered passport 100 before use for security purposes. Similar to the above registration process, the activation process may be performed remotely and may require the user to confirm and/or provide additional user information before the registered passport 100 is active and available for use to generate award-eligible events.

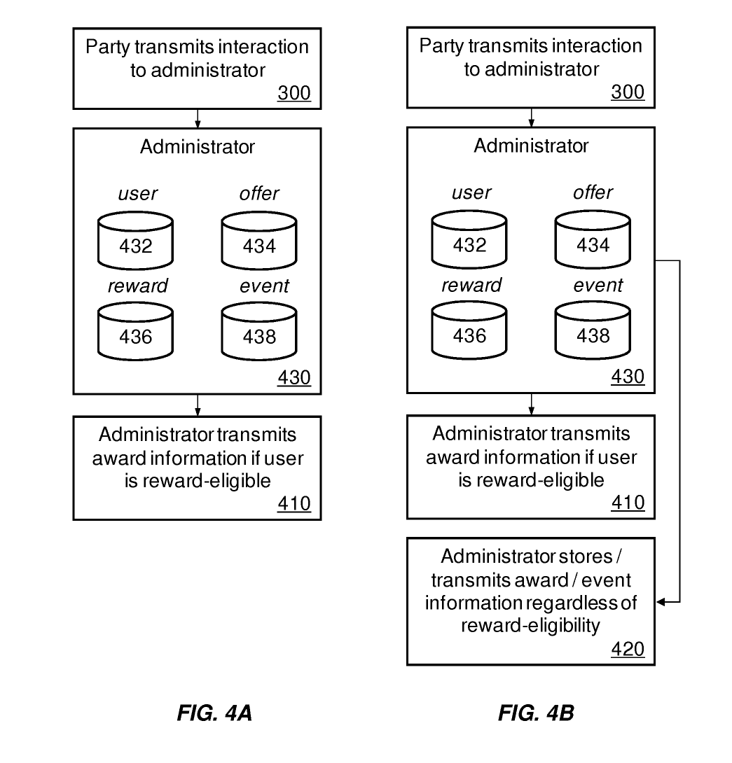

FIG. 4A is a diagram illustrating methods and systems for administering an affinity rewards program according to the disclosure. As shown in FIG. 4A, a rewards program administrator maintains at least one database 430 to store rewards program information relating to users participating in the program; sponsors participating in the program; past, present, or future offers available through the program; events performed by users and/or sponsors participating in the program (e.g., whether or not the event generated a reward); and/or awards disbursed through the program. While illustrated as being in the form of discrete electronic databases, the various information items can be stored in any convenient form, whether in a single or multiple electronic datafile(s).

For example, the administrator maintains a user database 432 having a plurality of user records. As described above, the user records can contain simply a passport index 110 or user identifier associated with a registered user. In other instances, the user records suitably can contain additional contact, demographic, or other user information.

The administrator additionally maintains an offer database 434 having a plurality of offer records. The collection of offer records can be associated with a single sponsor, but the offer records suitably represent a collection of offers from a plurality of different sponsors. The offer records include a sponsor identifier (e.g., name of sponsor and/or a sponsor identifier such as a sponsor identification code (SIC), which may link to another database containing additional sponsor information). The offer records further define at least one reward associated with the offer (e.g., where multiple rewards and/or a subset of multiple rewards may be available to a user completing the offer, such as based on user selection, sponsor selection, or a random selection). The offer records also define at least one interaction condition for the reward. Suitably, the interaction condition(s) required for user reward-eligibility can include at least one event/action performed by the user (e.g., visit/purchase/activity as described above) and/or at least one additional conditions/parameters defining reward-eligible user actions (e.g., interaction time, location, value, specific activity performed as described above). For example, an offer may require a user to perform an action at a specified date/time and/or location to generate an event potentially qualifying the user for a reward, where the specified date/time/location may be statically defined or dynamically defined (e.g., itself changing on a periodic basis or being defined in terms of other user events). In some cases, at least one element of an offer record (e.g., associated reward(s), required condition(s)) may be defined by the offer's sponsor to be hidden such that the hidden elements are not revealed to users or other sponsors upon a query of offer database 434 (e.g., to introduce an unknown or lottery-type element into an offer, for example combined with a random reward distribution from a plurality of available rewards). In other cases, an offer record may be dynamically defined in terms of a changing or variable interaction condition, for example based on the activities of other users participating in the rewards program (e.g., as determined with reference to an event database 438 described below and recording events/actions of a plurality of users in the rewards program). For instance, a reward may be offered only to pre-selected number of users performing the most of defined activity (e.g., top ten users visiting a location in a month; single user with the most purchases in a week).

The administrator receives from a party transmission 300 an event record that defines a specific interaction between the party and a user of the passport 100. The event record generally contains the user's passport index 110 or user identifier, the sponsor identifier for the transmission 300, and any event information items that characterize the particular interaction between the user and the sponsor. The event information items transmitted include data pertinent to the interaction conditions of at least one offer for the sponsor (e.g., user visit/purchase/activity; user interaction time, location, value, specific activity performed). In a physical interaction setting, the party reads the user's passport 100 and corresponding index 110 when the user performs an activity that potentially qualifies the user for a reward. For example, when the passport index 110 is a machine-readable user identifier, the user identifier can be scanned using an appropriate apparatus (e.g., optical scanner for a 2D barcode), for example by a party employee or by the user at an unattended scanning kiosk. The party then securely transmits the user's identifier, the corresponding sponsor identifier, and the interaction details to the rewards administrator (e.g., from a remote location over a data network or networks such as via the internet), for example being encrypted using on-demand minted codes for security and authentication by the rewards program administrator upon receipt.

The administrator then determines if the user is eligible to receive a reward according to the parameters of any existing sponsor offers. For example, the administrator compares the passport index 110 or user identifier from the received event record to information in the user database 432 to determine whether the index 110 or user identifier corresponds to a registered, active user generally eligible to receive rewards. The administrator also compares the event information item(s) and the sponsor identifier from the received event record to information in the offer database 434 to determine whether the user-sponsor interaction corresponds to reward-eligible activity for a given sponsor offer. In some cases (shown in FIG. 4B), the administrator may store (420) the event record in an event database 438. The administrator may store all event records, only event records that qualify a user for a reward, only event records that do not qualify a user for a reward, or any desired combination/subset of event records generated/received. In addition to user information, sponsor information, and event information, the event database 438 can further include an indication whether the stored event generated a reward and/or whether the reward has been claimed by/awarded to the user. Alternatively or additionally, information regarding reward distribution can be stored in a reward database 436.

If the administrator determines that the user is eligible to receive a reward, the administrator then transmits (410) reward eligibility information to at least one of the user and the party. A reward eligibility notification to the user can include instructions how to obtain the reward, such as by visiting a sponsor location or by completing a reward request (e.g., using a web interface provided by the sponsor or administrator). The notification can be provided by physical means (e.g., mail) or by electronic means (e.g., email, text message, web notification when the user next accesses his/her event history from the administrator database 430). A reward eligibility notification to the sponsor or associated party can include a specification of the rewards to which the user is entitled, for example so that the party can inform the user of reward eligibility and/or provide the reward directly to the user (e.g., at the time of the interaction 300). In either case, notification to the user or sponsor can be provided immediately upon determination or after some pre-selected time from determination by the administrator (e.g., when an offer requires multiple actions for reward and/or is interrelated to the actions of other users).

As shown in FIG. 4B, even when the particular interaction 300 does not qualify the user for a reward, the administrator may transmit (420) reward (in)eligibility information to at least one of the user and the party. With notifications similar to above, the user can receive from the administrator or from the party an update on its reward status, for example including an indication which reward conditions have been satisfied and/or which reward conditions still need to be satisfied to qualify the user for the reward (e.g., in relation to multi-part offers that require multiple events for completion before reward distribution).

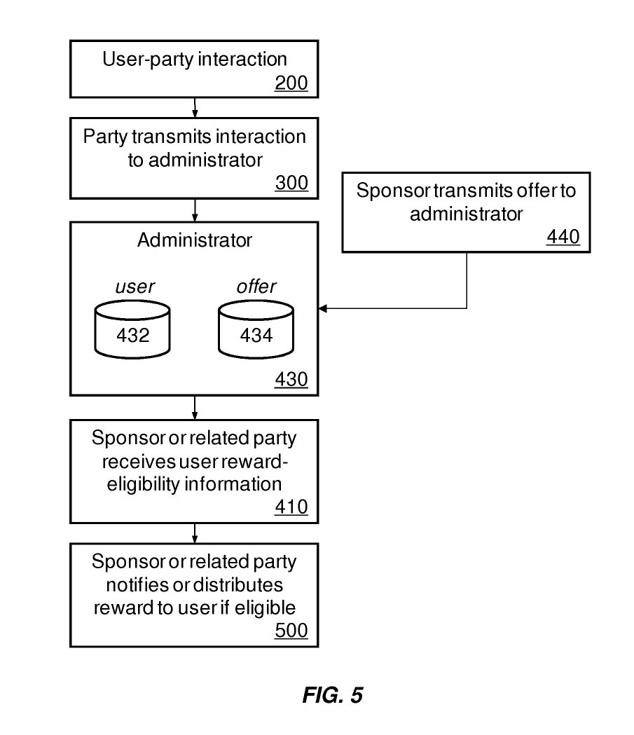

FIG. 5 is a diagram illustrating methods and systems for sponsor participation in an affinity rewards program according to the disclosure. As shown in FIG. 5, a sponsor participating in the affinity rewards program transmits (440) to the rewards program administrator database 430 at least one offer record defining the nature of its participation in the program. As described above, the offer record includes a sponsor identifier (e.g., SIC), a definition of at least one reward associated with the offer, and a definition of at least one interaction condition for the reward. The administrator 430 can store the offer record in any suitable form, for example in the offer database 434 as described above.

Similar to the manner described above, a party (e.g., the sponsor itself or other related party as described above) interacts (200) with a user to receive from the user the user's unique passport index 110 or user identifier (e.g., by scanning or otherwise reading the passport 100 to obtain the index 110). The user-party interaction 200 further defines corresponding event information between the user and the party. The party then transmits (300) to the administrator an event record for the interaction (200) (e.g., to a remote administrator location over a data network or networks such as via the internet). The event record generally contains the user's passport index 110 or user identifier, the sponsor identifier for the transmission 300, and any event information items that characterize the particular interaction between the user and the party. The sponsor or related party then receives (410) from the administrator an indication whether the interaction (200) and corresponding event information qualifies the user for the sponsor's reward (e.g., by meeting a sufficient number of interaction conditions according to the sponsor's reward/offer definition). In some instances, the sponsor or related party may notify or distribute (500) the reward to the user if the user is reward-eligible.

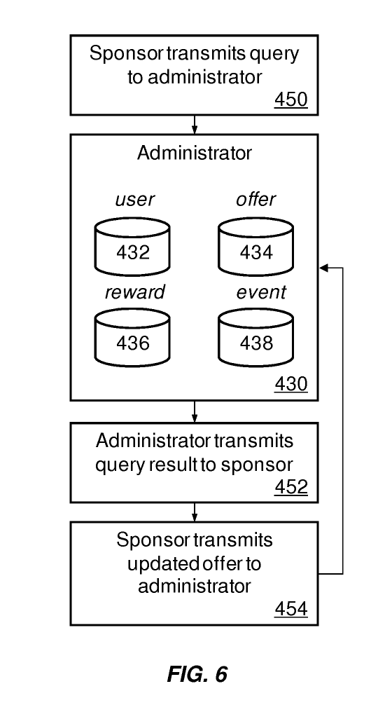

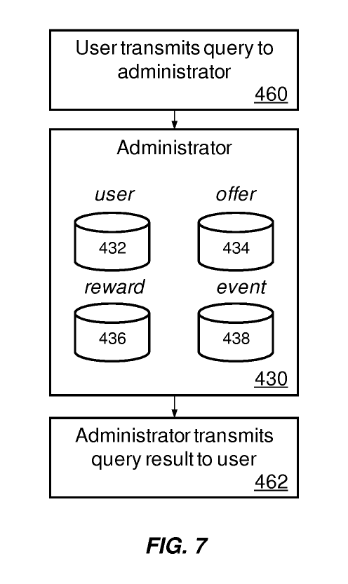

An advantage of the disclosed affinity rewards program is that it provides a platform for the dynamic and ad hoc implementation of a rewards program offer by a sponsor with little to no set-up or other infrastructure requirements for implementation. FIG. 6 is a diagram illustrating methods and systems for such dynamic sponsor monitoring and updating of its affinity rewards program according to the disclosure. As shown in FIG. 6, the sponsor transmits (450) and the administrator receives (430) a query corresponding to at least one condition related to data stored by the administrator. The query can represent a discrete request for information or the real-time monitoring of events satisfying a pre-selected condition. The query condition(s) can include, for example, at least one of an event condition, an offer condition, a user condition, and a reward condition provided by the sponsor that potentially matches or otherwise corresponds to at least one of an event database 438 condition, an offer database 434 condition, a reward database 436 condition, and a user database 432 condition. The administrator 430 evaluates the query condition(s) against its stored data, and the administrator then transmits and the sponsor receives (452) data corresponding to the query condition(s). As above, transmission and receipt of query conditions/results can be performed over a suitable data network (e.g., using encrypted data transmission over the internet).

Various aspects of this query/feedback functionality provide a useful tool for a sponsor to tailor its rewards program offer(s). For instance, a sponsor currently participating in the rewards program may query the event logs related to its own offers, for example to evaluate the relative success or failure of currently pending or past offers. In some cases, the administrator may permit a sponsor to query the event logs related to offers of different sponsors. Such information can be used as a predictive or planning tool by the sponsor to identify future offers that ideally will have some degree of success. For instance, by examining successful or unsuccessful events ultimately leading to reward distribution, the sponsor may identify time-, location-, reward-, and/or user-specific conditions that are more or less likely to induce user participation in a future offer. User activity can be tracked according to any desired geographic, demographic, etc. conditions to identify trends and improve targeting of offer conditions for future promotions. For example, the query may indicate that male users at sponsor location A are more likely to participate in a rewards program when a visit to sponsor location A between 11 am and 1 pm is required to generate a reward in the form of piece of promotional merchandise from the sponsor. Similarly, the query may indicate that female users at sponsor location B are more likely to participate in a rewards program when a purchase at sponsor location B between 2 pm and 3 pm is required to generate a reward in the form of a coupon/discount from the sponsor towards a future purchase.

As further shown in FIG. 6, the (essentially) real-time diagnostic tool allows the sponsor to transmit (454) and the administrator to receive (430) an updated offer record for the sponsor. The updated offer record includes a sponsor identifier (e.g., SIC), an updated definition of at least one reward associated with the offer, and/or an updated definition of at least one interaction condition for the reward. An updated offer record can represent an entirely new offer record or a change to an existing offer record for the sponsor. For example, the update may be in the form of a termination of a current offer that has met its promotional objectives (e.g., distribution of a specified number of rewards). Similarly, the update may be in the form of an alteration to an existing offer condition, such as expansion or contraction of time-, location-, reward-, and/or user-specific conditions for reward eligibility. In other cases, the updated offer record can represent an entirely new offer, for example based on historical event data suggesting potentially successful future offer parameters as described above.

FIG. 7 is a diagram illustrating methods and systems for user monitoring of its participation in an affinity rewards program according to the disclosure. As shown in FIG. 7, the user transmits (460) and the administrator receives (430) a query corresponding to at least one condition related to data stored by the administrator. The query condition(s) can include, for example, at least one of an event condition, an offer condition, a user condition, and a reward condition provided by the user that potentially matches or otherwise corresponds to at least one of an event database 438 condition, an offer database 434 condition, a reward database 436 condition, and a user database 432 condition. The administrator evaluates the query condition(s) against its stored data, and the administrator then transmits and the user receives (462) data corresponding to the query condition(s). As above, transmission and receipt of query conditions/results can be performed over a suitable data network (e.g., using encrypted data transmission over the internet).

Various aspects of this query/feedback functionality provide a useful tool for a user to tailor its participation in different rewards program offer(s). For example, a user may query the event or reward logs related to its own activity, for example to determine which offers are complete (e.g., for which the user can obtain a reward) and/or to determine the user's relative progress on incomplete offers (e.g., to identify remaining activities required for completion; to display the user's current ranking in an offer dynamically defined based on the activity of multiple users). In other cases, a user may query the offer logs, for example to identify potential offers of interest, such as based on a user's selection of time, location, and/or sponsor conditions of interest. In such cases, the user may be able to use or register an existing passport 100 to participate in the newly identified offers, or the user may be required to request a new passport 100 to participate in the newly identified offers (e.g., as illustrated FIG. 3B and described above).

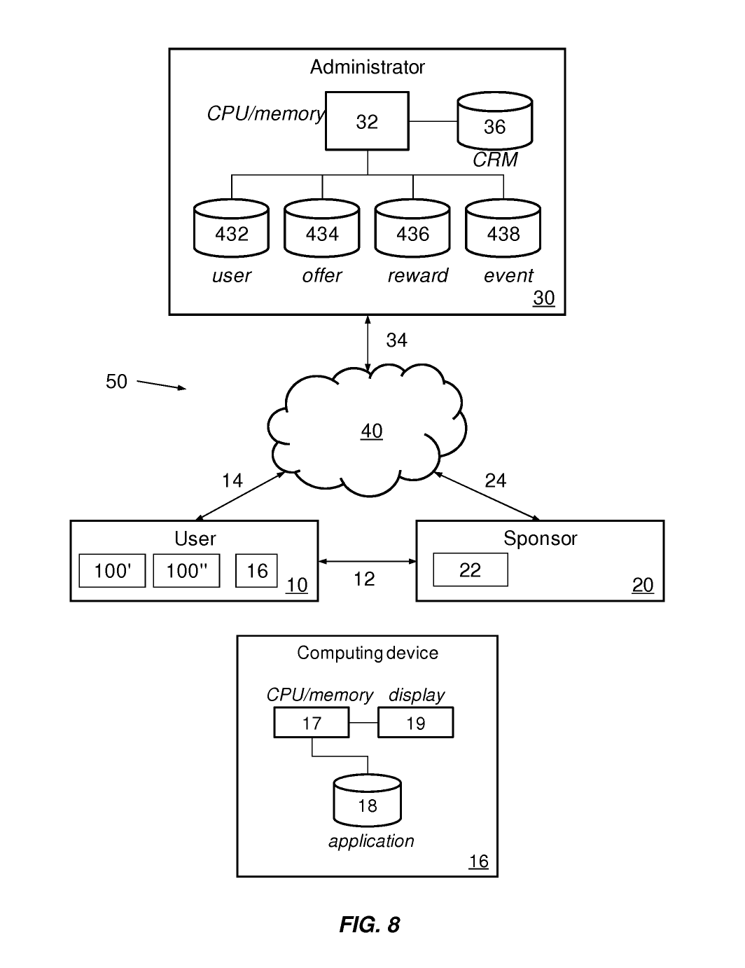

FIG. 8 shows a system 50 for administering an affinity rewards program. In the system 50, at least one user 10, at least one sponsor 20, and a rewards program administrator 30 participate in the program. In some cases, the sponsor 20 can include the business/entity that provides the offers/rewards as well as a sponsor-related party that interacts with the user 10 when performing reward-eligible actions. The user 10, the sponsor 20, and the administrator 30 can be remotely located relative to each other and can communicate electronically over a network or networks 40. The networks 40 may include a private network such as an intranet, a public network such as the internet, or a combination of multiple interconnected public and/or private networks. Connections 14, 24, and 34 represent wired and/or wireless connections for the user 10, the sponsor 20, and the administrator 30, respectively, to the networks 40, which connections 14, 24, and 34 permit electronic communication/interaction between any two parties in the system 50. For example, connections 14 and 34 permit user-administrator communication (e.g., for passport registration, administrator rewards notification, user rewards inquiry). Similarly, connections 24 and 34 permit sponsor-administrator communication (e.g., for passport registration, administrator rewards notification, sponsor offer/event inquiry, sponsor offer definition, sponsor transmission of user interaction). Connection 12 represents a direct physical interaction between the user 10 and the sponsor 20 (e.g., user performing reward-eligible action at the sponsor's location, sponsor providing a passport 100). For example, the sponsor 20 may scan a user's physical passport 100′ or digital passport 100″ using any suitable scanning apparatus 22 (e.g., optical scanner). Virtual user-sponsor interactions can be achieved via connections 14 and 24.

The administrator 30 includes at least one computer 32 (e.g., general purpose computer including a suitable processor coupled to memory, storage media, etc.) coupled to computer-readable media 36 (e.g., containing instructions for administering the rewards program) and to at least one database for storing program information (e.g., user database 432, an offer database 434, a reward database 436, and/or an event database 438 as above).

The user 10 can use a computing device 16 to interface with the sponsor 20 and/or administrator 30, for example to register the passports 100′, 100″ and/or to interact with the sponsor 20 in a rewards-program event. The computing device 16 may be a mobile computing device such as smartphone, tablet computer, music player, etc. The computing device 16 includes at least one processor/memory 17 (e.g., general purpose computer including a suitable processor coupled to memory, storage media, etc.) coupled to a computer display/monitor 19 (e.g., smartphone display). The processor/memory 17 additionally is coupled to computer-readable media 18 (e.g., including stored instructions for at least one local application, related databases, etc.), such as an application for user participation in the rewards program,

In one aspect, the disclosure relates to the computer-readable media 36 with instructions for administering the rewards program. The media 36 can include or be coupled to a user database 432, an offer database 434, and an event database 438 with corresponding user, offer, and event records. The media 36 contains stored instructions which, when executed by the at least one computer 32 coupled to the media 36, cause the computer(s) 32 to perform various rewards program operations. For example, the computer(s) 32 can: receive from the sponsor 20 an event record including user information (e.g., user identifier), sponsor information (e.g., sponsor identifier), and event information defining an interaction between the user 10 and the sponsor 20), store the event record in the event database 438, determine if the user 10 is eligible to receive the reward (e.g., by comparing the user information to the user database 432; by comparing the sponsor information and event information to the offer database 434), and/or transmit to the user reward eligibility information (e.g., if the user is eligible to receive the reward).

In another aspect, the disclosure relates to the computer-readable media 18 with instructions for user participation in the rewards program. The media 18 contains stored instructions which, when executed by the at least one processor 17 coupled to the media 18, cause the computer 16 to perform various rewards program operations for the user. For example, the computer 16 can: receive a unique user identifier associated with the affinity passport 100 including the user identifier in readable form and associated with an affinity rewards program (e.g., receipt by optical scanning); transmit to the rewards program administrator 30 user information associated with the user identifier; and activate the user identifier for participation in the affinity rewards program (e.g., yielding the registered passport 100′). In a further example, the computer 16 can display on the computer display 19 coupled to the processor 17 the user identifier in readable form (e.g., such that the computer 16 can serve as the digital passport 100″ with an optically scannable 2D barcode or other user identifier on the display 19).

In another aspect, the disclosure relates to the system 50 for administering an affinity rewards program. In this aspect, the system can include the at least one computer 16 or 32, which is coupled to the computer-readable media 18 or 36 as described above. The specific computer(s) 16, 32 usable in the system 50 are not particularly limited and can include, for example, digital computers, such as laptops, desktops, workstations, servers, blade servers, mainframes, personal computing devices, and other appropriate computers.

### EXAMPLES

The following prospective examples illustrate the disclosed methods and systems, but are not intended to limit the scope of any claims thereto.

### Example 1

A theme park sponsor establishes an affinity rewards program by supplying multiple offer definitions to a rewards program administrator. The theme park has four main attractions, and the park offers patrons rewards in the form of a food discount coupon for each attraction visited. As a bonus reward, the park offers a reward in the form of park clothing merchandise for patrons visiting all four attractions.

When a patron enters the theme park, the patron receives a pre-registered affinity passport displaying a barcode as a unique user identifier as well as information describing the reward offers provided by the park. As the patron visits the various attractions, a park attendant scans the passport. The park transmits the patron event to the rewards program administrator and subsequently receives notification from the administrator that the patron is eligible for the discount coupon. The park attendant then provides the patron with the discount coupon. When the patron visits the final attraction, the park attendant additionally informs the patron that the patron is eligible for the park clothing merchandise reward, which may be redeemable, for example, at various points in the park or at the park entrance/exit.

### Example 2

Example 2 is the same as Example 1, but the pre-registered passport received by the patron upon entry has a 2D barcode that additionally encodes a URL. When the patron scans the 2D barcode with his/her internet-enabled mobile computing device, the web browser of the mobile device is redirected to the encoded URL where the patron can request and receive a digital equivalent of the pre-registered passport from the rewards program administrator. In this case, the patron's mobile device is scanned by the park attendant, and the patron can elect to receive the food discount coupons as digital coupons delivered directly to the patron's mobile device.

### Example 3

A local coffee house sponsor with multiple locations in a metropolitan area establishes an affinity rewards program by supplying multiple offer definitions to a rewards program administrator. An affinity passport specific to the coffee house is available to patrons upon request, for example at a coffee house location or via the internet. The patron or the coffee house can register the passport, which has an optically scannable 2D barcode and is available in a physical or digital medium.

Location A of the coffee house provides a traditional rewards-type program in which five accumulated beverage purchases qualifies a patron for a free beverage. Location B of the coffee house provides a similar program, except that ten accumulated beverage purchases qualifies a patron for a free bag of coffee beans. Location A provides a lottery-type reward in which every purchase provides the patron with a (small) random chance to win a coffee mug. Location B provides a similar lottery-type reward in which a different 10-minute time window is secretly selected each day during which any purchase qualifies the patron for a coffee mug reward. In this example, the offer definitions for the first three programs can be static and need not change over time. The offer definition transmitted by the coffee house to the program administrator for the fourth program is updated on a daily basis as Location B selects the daily qualifying time window.

Patrons visiting the coffee house locations are advised of the various rewards programs by promotional material on the passport. A coffee house attendant scans a patron's passport with every purchase. The coffee house transmits the purchase event to the rewards program administrator and subsequently receives notification from the administrator whether the patron is eligible for either or both of the accumulated reward and the instant lottery-type reward (e.g., based on a randomly generated number for Location A or based on the purchase time for Location B).

### Example 4

Example 4 is the same as Example 3, except that the coffee house customers receive a periodic newsletter with news, specials, and promotional offers associated with the coffee house. The newsletter serves as a pre-registered passport and it has a 2D barcode that additionally encodes a URL. When the customer scans the 2D barcode with his/her internet-enabled mobile computing device, the web browser of the mobile device is redirected to the encoded URL where the patron can request and receive a digital equivalent of the pre-registered passport (including the news and promotional materials) from the rewards program administrator. In this case, the patron's mobile device is scanned by the coffee house employee, and the patron need not retain the newsletter as the passport (although the patron could choose to do so).

### Example 5

Example 5 is the same as Example 3, except that Locations A and B of the coffee house provide a combined offer in which the customer with the most visits in a one-month period to either Location A or B earns a reward in the form of a 25% discount coupon applicable to all purchases at either Location A or B for the subsequent month. A coffee house attendant scans a patron's passport with every visit to either location. The coffee house transmits the visit event to the rewards program administrator, and the event is stored in an event database. At the end of the month, the rewards program administrator determines which customer had the most visits out of all monthly customers, and the administrator transmits to both the coffee house and the winning customer information confirming the identity of the reward-eligible customer.

### Example 6

The host of a multi-sport, multi-venue sporting event participates in an affinity rewards program in which different sponsors provide rewards associated with different sports/different venues. Patrons of the sporting event receive a pre-registered affinity passport as in Example 1 or 2. Patrons who visit a given venue at least five times during the sporting event qualify for a merchandise reward from the venue's sponsor. For example, patrons visiting the track-and-field venue potentially qualify for track-related merchandise such as shoes from a shoe manufacturer/sponsor. Similarly, patrons visiting the swimming venue potentially qualify for swim-related merchandise such as swimwear from a swimwear manufacturer/sponsor. As the patron visits each sporting venue, an attendant for the sporting event host scans the passport. The event host transmits the patron event to the rewards program administrator and subsequently receives notification from the administrator whether the patron is eligible for the venue-specific reward. If so, the event host attendant additionally informs the patron that the patron is eligible for the venue-specific reward, which may be redeemable, for example, at the venue itself or at another location.

### Example 7

The host of a running race participates in an affinity rewards program in which different sponsors provide rewards associated with different segments/milestones of the race. Runner participants in the race event receive a pre-registered affinity passport in the form of a wearable RFID transmitter (e.g., wearable on the shoe, shirt, shorts, wrist, etc. of the runner). Runners passing a given race milestone (e.g., each 1 k-leg in a 5 km race) qualify for a reward from a race sponsor depending on their current race time or race position when passing the milestone. For example, the first 10% of all racers passing the 1 k-milestone receive a discount coupon from a restaurant sponsoring the race. Similarly, the first 5 racers passing the 2 k-milestone receive a discount coupon from a sporting goods store sponsoring the race. As a runner passes a race milestone, an RFID reader positioned by the race host at the milestone reads the runner's unique RFID code from the wearable RFID transmitter passport. The race host transmits the runner's user identifier and milestone event to the rewards program administrator and subsequently receives notification from the administrator whether the runner is eligible for the milestone-specific reward. A race host attendant informs the racer at the conclusion of the race regarding any rewards for which the runner is eligible.

Throughout the specification, where the methods, processes, systems, or apparatus are described as including components or steps, it is contemplated that the methods, processes, systems, or apparatus can also comprise, consist essentially of, or consist of, any combination of the recited components or steps, unless described otherwise.

We claim:

1. A method for administering an affinity rewards program, comprising:
receiving from a party an event record comprising a user identifier associated with an affinity passport comprising the user identifier in readable form and associated with the rewards program, a sponsor identifier, and event information defining a user-sponsor interaction;
determining if the user is reward-eligible, comprising:
comparing the user identifier to a user database, the user database comprising a plurality of user records, each user record comprising a unique user identifier, and
comparing the sponsor identifier and the event information to an offer database, the offer database comprising a plurality of offer records from a plurality of different sponsors, each offer record comprising a sponsor identifier, an offer reward, and an interaction condition for the reward; and
upon determining that the user is reward-eligible, transmitting reward eligibility information to at least one of the user and the party.

2. The method of claim 1, wherein the reward is selected from the group consisting of physical items, digital items, sponsor credit, money, and combinations of physical items, digital items, sponsor credit, and money.

3. The method of claim 1, wherein the event information and the interaction condition for the reward comprise at least one of interaction time, interaction location, interaction value, and interaction activity.

4. The method of claim 1, further comprising:
storing the event record in an event database;
receiving from the sponsor a query corresponding to at least one of an event database condition, an offer database condition, and a user database condition; and
transmitting to the sponsor rewards program data corresponding to the at least one query condition.

5. The method of claim 4, further comprising:
receiving from the sponsor an updated offer record comprising the sponsor identifier and at least one of an updated offer reward and an updated interaction condition for the reward.

6. The method of claim 1, further comprising:
authenticating the event record to verify at least one of valid party participation in the rewards program and event information integrity.

7. A method for sponsor participation in an affinity rewards program, comprising:
transmitting to a rewards program administrator an offer record comprising a sponsor identifier, an offer reward, and a reward interaction condition;
receiving from a user a unique user identifier associated with an affinity passport comprising the user identifier in readable form and associated with the rewards program;
transmitting to the rewards program administrator an event record comprising the user identifier, the sponsor identifier, and event information defining a user-sponsor interaction; and
receiving from the rewards program administrator an indication whether the event information meets the interaction condition and qualifies the user for the sponsor's reward.

8. The method of claim 7, further comprising:
if the user qualifies for the reward, providing the reward to the user.

9. The method of claim 7, wherein the reward is selected from the group consisting of physical items, digital items, sponsor credit, money, and combinations of physical items, digital items, sponsor credit, and money.

10. The method of claim 7, wherein the event information comprises at least one of interaction time, interaction location, interaction value, and interaction activity.

11. The method of claim 7, wherein the affinity passport comprises the user's identifier displayed thereon in the form of an optically scannable two-dimensional barcode encoding a uniform resource locator corresponding to the rewards program administrator.

12. The method of claim 7, further comprising:
registering the user identifier for the user with the rewards program administrator; and
providing the affinity passport to the user.

13. The method of claim 7, further comprising:
transmitting to the rewards program administrator a query corresponding to at least one of an event condition, an offer condition, a user condition, and a reward condition; and
receiving from the rewards program administrator rewards program data corresponding to the at least one query condition.

14. The method of claim 13, further comprising:
transmitting to a rewards program administrator an updated offer record comprising the sponsor identifier and at least one of an updated offer reward and an updated interaction condition for the reward, wherein the updated offer record is selected based on the query data received from the rewards program administrator.

15. A computer readable storage medium comprising:
an encoded computer program, the program comprising instructions that, when executed by a processor, cause the processor to:
receive a unique user identifier associated with an affinity passport comprising the user identifier in readable form and associated with an affinity rewards program;
transmit to a rewards program administrator user information associated with the user identifier; and
activate the user identifier for participation in the affinity rewards program.
